(19) United States
(12) Patent Application Publication
(10) Pub. No.: US 2007/0077535 A1
(43) Pub. Date: Apr. 5, 2007

(54) Method for the production of a set of dentures for an untoothed or partially toothed jaw

(76) Inventors: Manfred Wichmann, Marloffstein (DE); Michael Bergler, Erlangen (DE); Stefan Holst, Nurnberg (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/572,193

(22) PCT Filed: Sep. 15, 2004
(86) PCT No.: PCT/DE04/02073

§ 371 Date: Oct. 24, 2006

(30) Foreign Application Priority Data
Sep. 16, 2003 (DE) 103 42 656.6

(51) Int. Cl. A61C 8/00

(52) U.S. Cl. 433/174

(57) ABSTRACT

The method is used to produce a set of dentures for an untoothed or partially toothed jaw for dental care of patients, especially a set of dentures which are to be placed on implants that are to be newly fixed. Initially positioning screws provided with a capping element are inserted in the lingual-oral or palatinal region and/or on the crest of the jaw. A cast (6) is made, expressing the real situation of the jaw of the patient including the positioning screws (8). Corresponding positioning screws (8) are then inserted into the cast (6). Other technical work is carried out on the cast (6), i.e. a drilling jig (7) is manufactured for the implants to be positioned and/or a transfer jig is manufactured, in additional to dental work carried out in the mouth of the patient, i.e. the drilling jig (7) is used to position the implants and/or to block the supports for the implants with the transfer jig by respectively fixing them on the positioning screws (8) in the cast (6) or jaw.

The invention relates to a method for making a denture for a fully or partially edentulous jaw, for dental treatment of patients or technical dental measures, particularly for a denture to be placed on implants that have to be implanted for the first time. Furthermore, the invention relates to a screw to be used as a positioning screw according to the method.

Implants have become more and more important in the field of dentistry. Due to the large treatment spectrum and the new materials in combination with positive long-term studies and technical innovations, a clear change regarding treatment procedures can be observed. While the traditional concept of implant installation provides a stress-free healing period, the indication spectrum increasingly includes an immediate loading of the implants by means of long term provisional dentures. Simultaneously, in the future, treatment planning will more frequently take place in front of the PC, due to new software programs in connection with x-ray diagnostics.

For the time being, the accurate plotting of the oral cavity is still problematic as far as this program is concerned. Accurate repositioning of the so-called drilling templates, which are required for diagnosis and implantation, is not possible, due to the various required treatment steps (extractions, exposure of the bone, etc.)

By means of x-ray templates, the patient's existing bone structure is measured and a treatment schedule is established subsequent to diagnosis. The drilling templates are produced according to the treatment schedule. The attending dentist/technical uses the templates during the operation according to pre-implant diagnosis.

An exact positioning of the implants is particularly important if
the jaw is edentulous;
the patients lacks bone matter and the implants have to be exactly set or positioned in the remaining bone structures;
the implant is placed in the area of the front teeth;
prior to the operation, a fixed long-term provisional denture has already been prepared, which has to be reinstalled directly after the operation;
the patient is a tumor patient with reconstructed bone.

If the patient has a partial dentition, the drilling templates are preferably supported thereon. If the patient is edentulous, the templates are placed directly on the mucosa. A defined stable position, however, is no longer given.

The invention is based on the object of improving a method of the above-described kind such that both a faster, even if provisional, treatment of the patient and a simplified and more exact adjustment and manufacture of the dental prosthesis are achieved.

According to the invention; this object is attained by positioning screws provided with an attached element, screwed into the lingual-oral or palatal area and/or into the alveolar process so that an impression of the position of the positioning screws and capturing the actual structure of the patient's jaw is taken and, subsequently, corresponding positioning screws are installed in the impression; and so that finally, any further technical dental work is carried out on the impression, namely the manufacture of a drilling template for the implant to be installed and/or the manufacture of a transfer template as well as the realization of the technical dental work in the patient's mouth, that is the application of the drilling template for the insertion of the implants and/or the interlocking of the impression post of the implants with the transfer template by fixation at the positioning screws in the impression or in the jaw.

The advantages achieved by means of the invention are further seen in the following and consist, first, in the fact that the screws can be positioned in the exact same way in each treatment step. Thus, the measures planned prior to the treatment can be exactly reproduced/realized, even with changing conditions in the oral cavity (for example because of extractions, exposure of the bone). As a result, a high-quality provisional denture can be thus produced in one day, a fact that might be of particular importance for people in public life.

The choice regarding the arrangement of the positioning screw is only limited by anatomical conditions.

Thanks to a suitable design of the positioning screw, it can also be used for complex treatments that are hard to do by means of conventional procedures (tumor reconstructions).

The combination of exact positioning with advanced methods for diagnostic examination can be optimized by the use of the invention (among other things: three-dimensional treatment planning, CT templates, computer-calculated positioning of the implants).

In order to avoid inaccuracies that are to be expected, the positioning screws should serve as temporary posts on which in every treatment session x-ray templates and drilling templates can be positioned in the exact same way.

In a preferred embodiment of the invention at least three positioning screws are inserted into each jaw. This fact is important since this way a stable support of the templates is ensured. Using more than three screws, however, is also possible and recommended. Only circumstances regarding the anatomy or the planning might be the cause of possible limitations.

Furthermore, it is possible within the framework of the invention to provide the positioning screws such that they can either be screwed-in with the help of a pilot drill or by means of self-tapping screws.

If the latter are used, these resemble so-called “drill-free” screws that can be installed in any position in the maxillary or mandibular bone. Drill-free screws are advanced conventional self-cutting osteosynthesis screws that can be set in the bone in a “self-tapping” manner without a manual pilot hole having to be made beforehand. Both types of screws can be used as positioning screw according to the invention. Whether a pilot hole is made or whether a drill-free screw is used depends on the preferences of the attending dentist and on the site within the oral cavity. Among the disadvantages of a pilot hole are, on the one hand, the additional step and, on the other hand, the fact that retention of conventional screws is reduced by the drill.

As far as clinical application of the drill-free screws is concerned, their use in the midfacial area is unreservedly recommended. Normally, the cortical layers in the maxilla are thin, which simplifies the insertion of drill-free screws. With an increasing thickness of the cortical layer, more and more effort is necessary for the insertion of the screws, and simultaneously the incidence of complications is higher. In the lateral midfacial area, setting of drill-free screws in the area of the mandibular paramedian and mandibular corpus is still possible. Within the area of the mandibular angle, the use of drill-free screws by means of intraoral approaches is contraindicated in adult patients, since the insertion primarily fails or can only be carried out partially due to the thick cortical layer in this area.

The device-related object of the invention is attained by a screw used as positioning screw according to the above-described method, characterized by a threaded front part, working surfaces for the application of a screw driving tool and by a contact surface for the templates and parts to be positioned.

The invention relates to a screw that consists of an acceptable material and that is temporarily anchored in the bone. Insertion and removal are carried out transgingivally (through the mucosa) without prior incision of the mucosa.

Conveniently, the screw has a smooth threadless shank between the threaded front part and the working surfaces.

Furthermore, it is provided within the framework of the invention that the working surfaces are formed by a hexagonal nut and that the contact surface is formed by a spherical head, the spherical head having a smaller diameter than the hexagonal nut.

The hexagonal nut of the screw also serves as screw head for the screw setter or remover and simultaneously as a stop when the screw is set in the bone.

The spherical head ensures a common insertion direction when several screws are used in different axial orientations; furthermore, it serves as transfer point for making the plaster model. Moreover, the spherical head has a stabilizing function during insertion of the screw into the bone. In principle, the spherical head serves as male part for any sort of-snap attachment.

Finally, the screw can be advantageously designed in two parts, the spherical head being detachably connected to the shank, for example such that it can be screwed in.

In the following, the invention is to be further illustrated by means of an embodiment shown in the drawings. Therein:

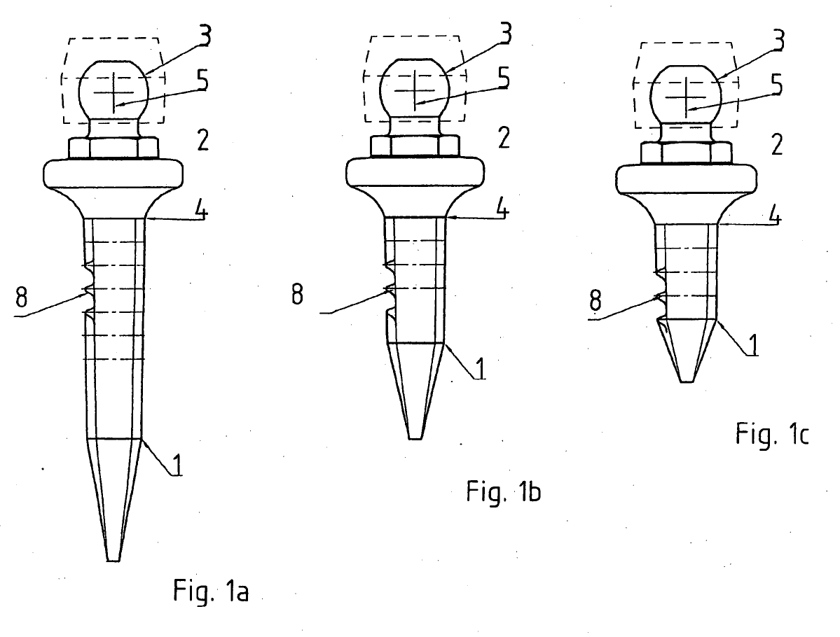

FIG. 1 shows top views of three embodiments of the positioning screw according to the invention;

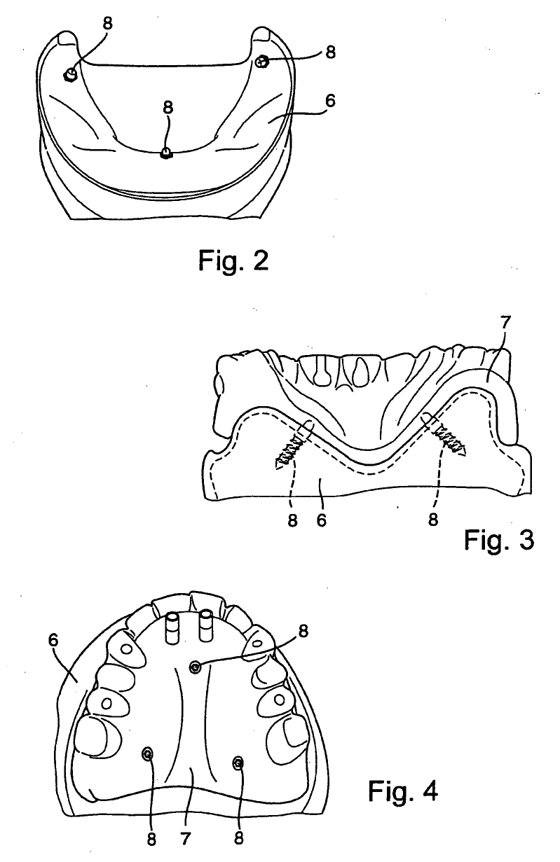

FIG. 2 is a top view of a jaw model with installed positioning screws;

FIG. 3 is a section through a jaw model with installed positioning screws;

FIG. 4 is a jaw model with a drilling template placed on the positioning screws.

The screw displayed in FIG. 1, in the following called positioning screw 8, is used in a method, for making a denture for a fully or partially edentulous jaw within the framework of dental treatment of patients or technical dental measures. It is particularly used when a denture has to be placed on implants that have to be installed.

In this connection, the positioning screws 8 provided with attached elements are at first installed in the lingual-oral or palatal section and/or on the alveolar process. Subsequently an impression 6 of the positioning screws and capturing the actual state of the patient's jaw is taken. Thereafter, corresponding positioning screws 8 are set in the impression 6, so that finally the further technical dental work is carried out on the impression 6, namely the fabrication of a drilling template 7 for the implants to be installed and/or the fabrication of a transfer template.

The technical dental work in the mouth of the patients is carried out in the same way; this work comprises the application of the drilling template 7 for the insertion of the implants and/or the interlocking of the impression posts of the implants with the transfer template, by fixation at the positioning screws 8 in the impression 6 or in the jaw. Accurate work is guaranteed since the positioning screws 8 are provided in the jaw correspondingly to their arrangement on the model.

As can be seen from FIG. 2, at least three positioning screws 8 are used in each jaw. The positioning screw 8 of FIG. 1a can be installed by means of a pilot hole; the screw illustrated in FIG. 1b, on the other hand, can be set in the bone in a self-tapping manner, such that a pilot hole is not required.

As shown in detail in FIG. 1, the positioning screw 8 has a threaded front part 1, working areas 2 for the application of an insertion tool, as well as a contact surface 3 for the templates and parts to be positioned. A shank 4 without a thread is provided between the threaded front part 1 and the working areas 2.

The working areas 2 are formed by a hexagonal nut and the contact area 3 by a spherical head 5, the spherical head 5 having a smaller diameter than the hexagonal nut.

The stability of the positioning screws 8 in the bone is due to the law of the inclined plane; the thread is created by winding the inclined plane on a cylinder. The inclination of the thread guarantees the stability of the screw.

The stop prevents the screw from being installed too deeply into the bone. At the same time, it serves as screw head for the setting tool used for the insertion into the bone and for the later removal.

Since the screw is only temporarily set in the jaw bone, its sole function consists in gaining a primary stability. Osseointegration, which is the primary object for conventional implants, is not required.

The screws can be removed in the same session, subsequent to the insertion of the implants. If required, the screws may also remain in situ for a longer period of time, in case further treatments are to be carried out by means of the screws.

The screw head consists of a sphere situated on the stop. The dimensions of this spherical head are slightly smaller than the diameter of the stop. This ensures that the setting tool fits over the sphere. At the same time, the setting tool is stabilized, since its inner surface abuts the outer surface of the sphere when the screw is installed.

A further reason for providing a screw head 5 consists in the fact that, if several screws are used, positioning/angulation in the jaw may be arbitrary, nevertheless providing a common insertion direction for the auxiliary means to be anchored (see FIGS. 2 and 3).

The diameter of the sphere and the stop are selected such that the spherical head 5 is, not countersunk under the mucosa. Thanks to the spherical design, oral structures are not irritated during the period of the anchoring in the bone. It is highly advantageous for the patient that exposure operations for the removal of the screws are not required (see FIGS. 2 and 3).

The screws according to the invention correspond in their dimensions more or less to the osteosynthesis mini or micro screws used for fracture healing. These osteosynthesis screws serve for the stabilization of fractured fragments in gracile anatomical structures. Due to their small dimensions, these screws can be set in the alveolar process both vertically and horizontally, the central palatine process or the distal areas of the jaw.

Since the mini-screws with spherical heads are installed by direct transgingival insertion (without the mucosa being opened), treatment stress is minimal for the attending surgeon and the patient. The installation can be carried out within a few minutes under local anesthesia, such as used for conventional dental treatment.

Among the disadvantages of the temporary implants used so far'are the high costs for patients and the fact that they do not have a spherical head 5 but instead have abutment posts. This leads to the fact that insertion into the maxilla bone must be exclusively vertical, which on the other hand results in a significantly limited space offered for the definite implants.

Recapitulating, it can be stated that the transfer implants are created for long-term provisional dentures and cannot be used for temporarily stabilizing templates because of the large treatment efforts.

There are various working groups within the field of implantology trying to use “Lego blocks” for a defined positioning of x-ray templates for CTS. These stabilizing methods, however, require enormous time and effort as far as fabrication and insertion are concerned, both from the attending dentist and the patient. Therefore, it is another advantage of the screws with spherical heads that they can be quickly installed and impressions can be taken with any material used in practice by the attending dentist in one and the same session.

The insertion of the developed screw is independent of anatomical conditions and helps to avoid additional costs caused by complex manufacturing procedures in the laboratory.

The steps required for the manufacture of a template comprising the newly developed screws with spherical heads, correspond to those necessary for the fabrication of a conventional drilling template 7, with the exception that the female molds have to be polymerized into the drilling template 7. Due to the possible accuracy and the simple handling, the invention is highly advantageous for any dentist working in-the field of implantology, with the time and effort being minimized and the costs for the patients being only slightly increased.

1. A method of fabricating a denture for a fully or partially edentulous jaw for dental treatment of patients or technical dental measures, particularly a denture to be placed on implants that are installed for the first time, wherein, first, positioning screws provided with an attached element are screwed into the lingual-oral or palatal area and/or into the alveolar process so that an impression (6) of the positioning screws (8) and capturing the actual state of the patient's jaw is taken and subsequently corresponding positioning screws (8) are installed in the impression (6) and that ultimately further technical dental measures are carried out on the impression (6), that is, the manufacture of a drilling template (7) for the implants to be installed and/or the manufacture of a transfer template as well as the technical dental work in the mouth of the patient, that is, the application of the drilling template (7) for insertion of the implants and/or interlocking of the impression posts of the implants with the transfer template by fixation at the positioning screws (8) in the impression (6) or in the jaw.

2. The method according to claim 1 wherein at least three positioning screws are installed per jaw.

3. The method according to claim 1 wherein the positioning screws (8) are either set in the bone with the help of a pilot hole or in a self-tapping manner.

4. A screw to be used as positioning screw (8) according to the method of claim 1, comprising:
a threaded front part,
working surfaces (2) for the application of a screw-driving driving tool and
a contact surface (3) for the templates and parts to be positioned.

5. The screw according to claim 4 wherein a shank without a thread is provided between the threaded front part (1) and the contact surfaces (4).

6. The screw according to claim 4 wherein the working surfaces (2) of a hexagonal nut and the contact surface (3) are formed by a spherical head (5), the spherical head (5) being of a smaller diameter than the hexagonal nut.

7. The screw according to claim 4 wherein it is designed in two parts, the spherical head (5) being detachably connected to the shank (4) and being possibly, for example, screwed-on.
